(19) United States
(12) Patent Application Publication
(10) Pub. No.: US 2017/0272365 A1
(43) Pub. Date: Sep. 21, 2017

(54) METHOD AND APPRATUS FOR CONTROLLING NETWORK TRAFFIC

(71) Applicants: HON HAI PRECISION INDUSTRY CO., LTD, New Taipei (TW); NATIONAL TAIWAN UNIVERSITY, TAIPEI (TW)

(72) Inventors: HUNG-YU WEI, TAIPEI (TW); CHUN-TING CHOU, TAIPEI (TW); YU-JEN KU, TAIPEI (TW); DIAN-YU LIN, TAIPEI (TW); CHIA-FU LEE, TAIPEI (TW)

(21) Appl. No.: 15/458,806

(22) Filed: Mar. 14, 2017

Related U.S. Application Data
(60) Provisional application No. 62/308,611, filed on Mar. 15, 2016.

(51) Int. Cl. H04L 12/813; H04L 12/859; H04L 29/06; H04L 12/841

(52) U.S. Cl. CPC H04L 47/20; H04L 47/283; H04L 47/2475; H04L 65/1063

(57) ABSTRACT

A method for managing a network traffic of a radio access network, the method comprising steps of identifying, by a processor of a baseband unit (BBU), at least one characteristic of a data traffic received from at least one user equipment, and determining, by the processor, whether to process locally at an edge node or at a remote service network in response to the at least one characteristic of the data traffic received from the user equipment.

### CROSS REFERENCE

This application claims the benefit of U.S. Provisional Application Ser. No. 62/308611, filed on Mar. 15, 2016, and entitled “METHOD AND APPARATUS FOR CONTROLLING NETWORK TRAFFIC”, which is incorporated herein by reference in its entirety.

### TECHNICAL FIELD

The present disclosure relates generally to the field of wireless communications, and pertains particularly to method and apparatus for controlling and managing network traffic in a radio access network including edge computing capability.

### BACKGROUND

The use of mobile communication networks has increased over the last decade to meet an increasing demand for applications and services by users. As a result, data content being transferred over the network has become increasingly complex to meet the demands. The increased demand also results in diverse communication devices, new network equipment, new servers, and new type of communication devices to handle each new type of data. In distributed or cloud-based networking environments (e.g., C-RAN) where multiple communication devices may communicate and interact with each other to share, collect, and analyze information across different services and applications over the network, it is becoming progressively challenging to efficiently handle and process complex data content generated by increasingly diverse communication devices. Therefore, there is room for improvement in the art to developing a mechanism to efficiently control network data flow and effectively utilize the network resources.

### BRIEF DESCRIPTION OF THE DRAWINGS

Aspects of the present disclosure are best understood from the following detailed description when read with the accompanying figures. It is noted that various features are not drawn to scale, the dimensions of various features may be arbitrarily increased or reduced for clarity.

FIG. 1 is a diagram illustrating exemplary system architecture of a cloud-based radio access network in accordance with an exemplary embodiment of the present disclosure.

FIGS. 2A to 2B are schematic diagrams illustrating network operations of cloud-based radio access networks in accordance with exemplary embodiments of the present disclosure.

FIGS. 3A to 3C are diagrams illustrating CPU computing capacity for delay tolerable and delay sensitive traffic load in accordance with exemplary embodiments of the present disclosure.

FIG. 4 is a diagram illustrating a data processing and forwarding operation of a Fog radio access network in accordance with exemplary embodiments of the present disclosure.

FIG. 5 is a diagram illustrating an exemplary method for managing network traffic in accordance with an exemplary embodiment of the present disclosure.

FIG. 6A shows a resource allocation setting for a Fog radio access network in accordance with an exemplary embodiment of the present disclosure.

FIG. 6B shows a downlink/uplink resource allocation model for a Fog radio access network in accordance with an exemplary embodiment of the present disclosure.

FIGS. 6C and 6D show resource allocation settings for various Fog radio access networks in accordance with exemplary embodiments of the present disclosure.

FIGS. 6E to 6F are diagram illustrating the CPU resource allocation and the capacity region for the local BBU in accordance with exemplary embodiments of the present disclosure.

FIG. 7 is a diagram illustrating a network traffic processing operation model for a Fog radio access network in accordance with an exemplary embodiment of the present disclosure.

### DETAILED DESCRIPTION

The following disclosure provides different embodiments, or examples, implementing different features of the provided subject matter. Specific examples of components and arrangements are described, these being merely examples and not intended to be limiting. For example, the formation of a first feature over or on a second feature in the description that follows may include embodiments in which the first and second features are formed in direct contact, and may also include embodiments in which additional features are interposed between the first and second features, such that the first and second features may not be in direct contact. In addition, the present disclosure may repeat reference numerals and/or letters in the various examples. This repetition is for the purpose of simplicity and clarity and does not in itself dictate a relationship between the various exemplary embodiments and/or configurations discussed.

The term “comprising” means “including, but not necessarily limited to”; it specifically indicates open-ended inclusion or membership in a so-described combination, group, series, and the equivalents. The term “coupled” is defined as connected, whether directly or indirectly through intervening components, and is not necessarily limited to physical connections.

For consistency and ease of understanding, like features are identified (although, in some instances, not shown) with like numerals in the exemplary figures. However, the features in different embodiments may differ in other respects, and thus shall not be narrowly confined to what is shown in the figures.

Exemplary embodiments of the present disclosure that are described largely in the context of a functional computer processing system for data traffic control and routing for network edge computing. The present disclosure may also be embodied in a computer readable product disposed on data bearing media for use with any suitable computational and data processing device with communication processing capabilities (e.g., LTE protocol processing). Such data bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, Ethernet.

Persons skilled in the art will immediately recognize that any computer system having suitable programming means will be capable of executing the steps of the method of the present disclosure as embodied in a computer readable product. Persons skilled in the art will immediately recognize that, although some of the exemplary embodiments described in this specification are oriented to software installed and executing on computer hardware, nevertheless, alternative exemplary embodiments implemented as firmware or as hardware or combination of hardware and software are well within the scope of the present disclosure.

It has been known in the art that due to the long data transmission path and therefore high latency, cloud-based radio access network (C-RAN) can only serve delay tolerant data traffic and unable to serve delay sensitive data traffic, thereby existing C-RAN architecture does not meet the heavy distribution, low latency, and flexibility requirements of the next generation radio access network (e.g., 5G/new radio) standard. The present disclosure discloses a method and a multi-tier network architecture that is capable of utilizing the available and/or remaining computing resource in a local baseband unit (BBU) and/or a core network to provide computing service and process the data traffic locally, thereby providing shortened data transmission path and low latency service.

The present disclosure further discloses traffic admission control and resource allocation methods or policies implemented in the local BBU and/or the core network for serving low latency (or delay sensitive) and high latency (or delay tolerant) traffic simultaneously. Specifically, when delay sensitive traffic arrives, the local BBU can decide whether to process the incoming data traffic locally or to forward the incoming data traffic to next computing-based tier (e.g., a core network or a service/application network) based on its available and/or remaining computing resource.

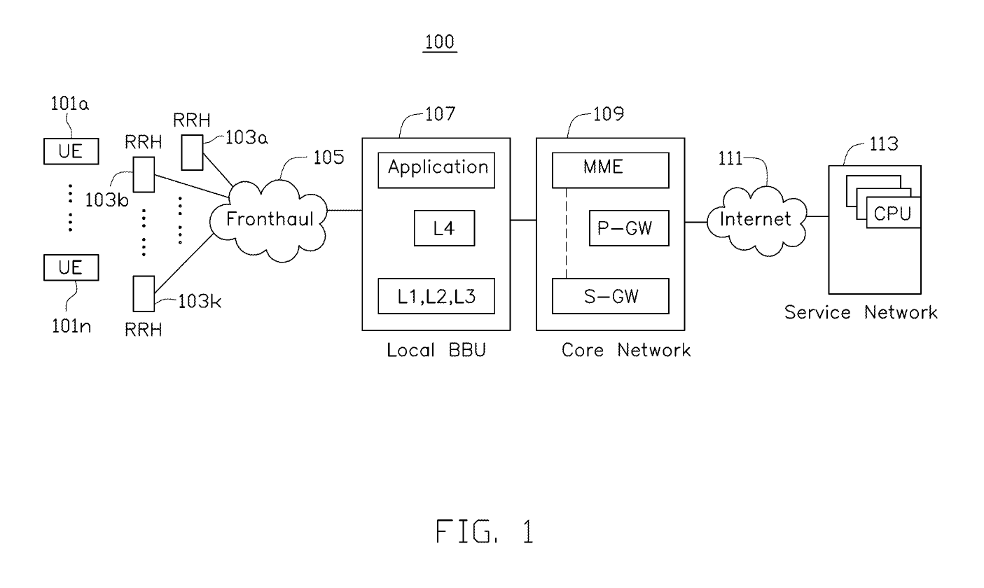

FIG. 1 shows a network architecture of a Fog radio access network in accordance with an exemplary embodiment of the present disclosure. FIG. 1 shows a network architecture of a Fog radio access network (Fog-RAN) 100 that adopts a cloud-based radio access network (C-RAN) multi-tier network architecture. In some embodiments, the Fog-RAN network 100 further adopts a traffic admission control policy for effectively and efficiently controlling and processing data flow in the network.

As shown in FIG. 1, the Fog-RAN network 100 includes one or more user equipments (UEs) 101a to 101n, an RRH infrastructure network including a plurality of RRH stations 103a, 103b, to 103k, a baseband unit (BBU) 107, a core network 109, and a service network 113.

In an exemplary embodiment, each of the UEs 101a to 101n includes smart phones, tablets, wearable devices, laptops, and vehicle-borne communication devices (e.g., cars, boats). In some embodiments, the UEs 101a to 101n include all of the same type or all of different type of user equipments in the Fog-RAN network 100.

In the present exemplary embodiment, one or more UEs 101a to 101n (also collectively referred to as UEs 101) in the Fog-RAN network 100 interact with various RRH stations 103a to 103k (also collectively referred to as RRHs 103), while the UEs 101 are operated within the coverage of the respective RRHs 103 over a communication network, wherein the k and the n are integers. In some embodiments, the RRHs 103 further communicate with the BBU 107 over the fronthaul network 105.

In the present exemplary embodiment, the fronthaul network 105 is equipped with a software-defined fronthaul (SD-FH) controller (not explicitly shown), which is capable of managing the fronthaul network resources and establishing bridging connections between the BBU 107 and the RRHs 103. In the present exemplary embodiment, the bridging connections include physical network connections, and are implemented in wired links, wireless links, or a combination of link types. In at least one exemplary embodiment, the bridging connections utilize the Common Public Radio Interface (CPRI) standard, the Open Base Station Architecture Initiative (OBSAI) standard, or other suitable fronthaul communication standards, or combinations of these standards.

In the present exemplary embodiment, the BBU 107 serves the first-tier of the Fog-RAN network 100 and controls data traffic flow in the Fog-RAN network 100. The BBU 107 includes a central processing node and an edge node and software and hardware, which are necessary for performing essential signal transmission/reception, computational operations, and LTE (or 5G) communication processing.

In the present exemplary embodiment, the central node monitors the computation resources of the edge node, to allocate computation resource sharing by the edge node and to perform communication processing including data communication, LTE processing, baseband processing, L1 to L3 (low layer protocol processing), and L4 (high layer protocol processing). In the present exemplary embodiment, the edge node performs application services and mobile edge computing operations for processing data locally, which includes at least but is not limited to incoming data traffic processing, video encoding/decoding, caching, requests issuing, and responses obtaining.

In the present exemplary embodiment, the edge node is implemented by a local application server installed in the BBU 107. In another exemplary embodiment, the edge node is disposed nearby or close to the location of the BBU 107. In some embodiments, the edge node includes an electronic apparatus with computing and communication processing capability.

In some embodiments, the BBU 107 further includes an admission control module (not explicitly shown in FIG. 1) installed therein for implementing an admission control policy and managing network resources. The admission control module operatively manages and routes the incoming data traffic according to the admission control policy upon the BBU 107 receiving the incoming data traffic from one or more of the RRHs 103. More specifically, upon receiving the incoming data traffic sent by the UEs 101, the admission control module operatively determines whether to admit the incoming data traffic to the BBU 107, how much incoming data traffic to be admitted, and the handler of the incoming data traffic, e.g., whether to process the data traffic locally at the edge node or to forward the traffic to the next tier (e.g., the core network 109 or the server network 113) according to the admission control policy.

The admission control policy may be configured to take into account factors such as, but is not limited to, the traffic load, computation loading of the current network equipment (e.g., the edge note), and the computational loading for the admitted traffic flow.

In an exemplary embodiment, the admission control policy may be configured in response to the delay requirements of data traffic flows (e.g., delay sensitive data traffic flows, delay tolerable data traffic flows).

In an exemplary embodiment, the admission control policy may be configured to take into account the volume of the incoming data traffic. The transmitting rate of a traffic flow might affect the CPU computing loading of the network equipment. For instance, a 10 Mbps flow might consume more computational resource than a 9 Mbps flow in a GPP platform. Thus, with an incoming data traffic of 10 Mbps, the admission control module may determine whether to process the data traffic locally or forward the data traffic to the next tier based on the current CPU computing loading and the required computing resources for handling the data traffic.

In an exemplary embodiment, the admission control policy may be configured based on the available computation resources at the location application server (or the edge node) and the required computational resource for application processing of the incoming data traffic (i.e., the amount of the CPU computational loading after admitting a newly incoming data traffic to the edge node). For instance, under the available computation-resource-based admission control policy, the admission control module may admit more data traffic when current CPU loading on the GPP platform is low and is sufficient to process and handle the data traffic.

In an exemplary embodiment, the admission control policy may be configured based on the required computational resource for communications processing (e.g., baseband processing, and higher layer protocol processing) of the incoming data traffic.

In an exemplary embodiment, the admission control policy may be configured based on at least one of the volume of the incoming data traffic, the computational resources available at the local application server (or the edge node), required computational resources for communications processing, and any combination thereof.

In some exemplary embodiments, the admission control policy may be pre-configured and pre-stored in the memory of the local application server via written firmware or programmed software.

The admission control module may be installed in a small cell base station with mobile edge computing capability, such as the BBU 107. In another exemplary embodiment, the admission control module may also be installed in a network infrastructure network equipment with a pool of baseband processing units (e.g. C-RAN), wherein in the C-RAN equipment may at least include computing capability for service or application processing (e.g. Fog computing capability or mobile edge computing capability). In yet another exemplary embodiment, the admission control module may be installed in a general purpose processor (GPP) based wireless network infrastructure equipment, such as a CPU-based (e.g. x86 platform) base station platform running LTE protocol software (or 5G protocol software) and capable of performing encoding/decoding and baseband processing. Those skilled in the art can configure and install the admission control module based on the network architecture and operational requirements.

The admission control module may be implemented by software or hardware implementation depending on the type of equipment and the system architecture of the equipment that the admission control module is to be installed.

The core network 109 serves as the second tier of the Fog-RAN network 100 and accommodates the network communication for the Fog-RAN network 100 via off-loading computation loading of the BBU 107. The core network 109 is communicatively coupled to the BBU 107 and the service network 113. Specifically, the core network 109 may be either physically or wirelessly connected to the BBU 107. The core network 109 communicates with the service network 113 via an internet 111 using Internet Protocol and World Wide Web. The core network 109 may include the mobility management entity (MME), the packet data network gateway (PDN-GW) and the Serving Gateway (S-GW).

The service network 113 serves as the third tier of the Fog-RAN network 100 and performs data computation and processing related to application/services. The service network 113 may in an exemplary embodiment be implemented by a cloud computing server or a remote application server. The service network 113 may also in an exemplary embodiment, be implemented by a data center or any cloud-based computing platform.

Briefly, when the central node of the BBU 107 receives an incoming data traffic (e.g., data packets) from one or more of the UEs 101 via the corresponding RRHs 103 and the fronthaul network 105, the admission control module of the BBU 107 operatively determines the amount of data traffic to be admitted to the BBU 107 for local processing, and determines whether to forward the data traffic to the later tier (e.g., the core network 109 and/or the service network 113) to process according to the type of the data traffic and the admission control policy (e.g., data traffic type, data traffic volume, available computational resource, required computational resource for handling the data traffic, and the like).

It is worth noting that FIG. 1 illustrates a three-tier Fog-RAN network architecture utilizing the admission control policy includes an edge node, a core network, and a service network. However, in another exemplary embodiment, the admission control policy may further be adopted with the fifth generation mobile communication) reference architecture (5 GMF), which includes an edge cloud (e.g., a BBU pool), a core cloud, and a service cloud. In yet another exemplary embodiment, the admission control policy may be adopted a two-tier Fog-RAN network architecture that includes an edge node or an edge cloud and a service cloud. Hence, FIG. 1 merely serves as an exemplary multi-tier Fog-RAN network architecture for illustrating the admission control methodology, and should not limited the present disclosure.

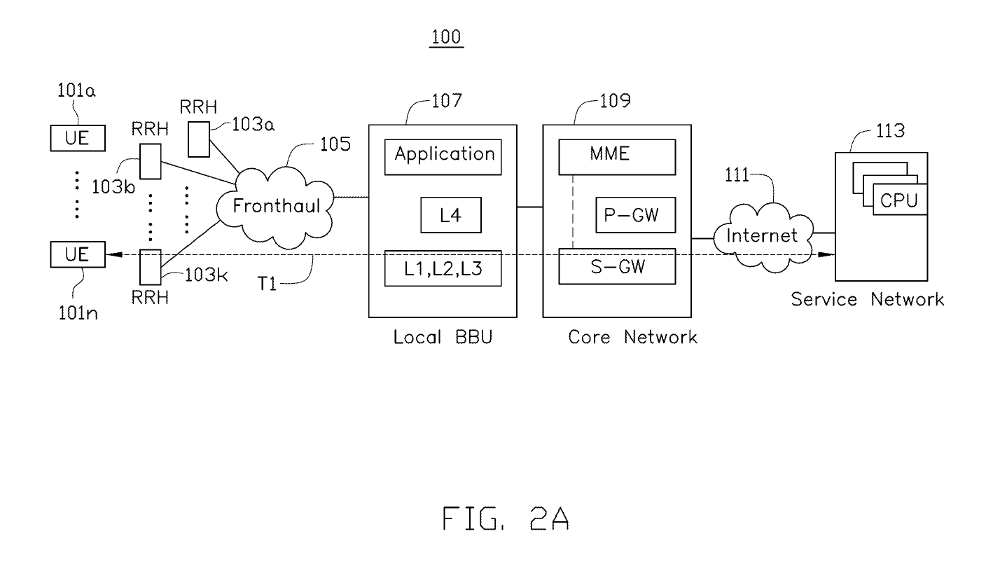

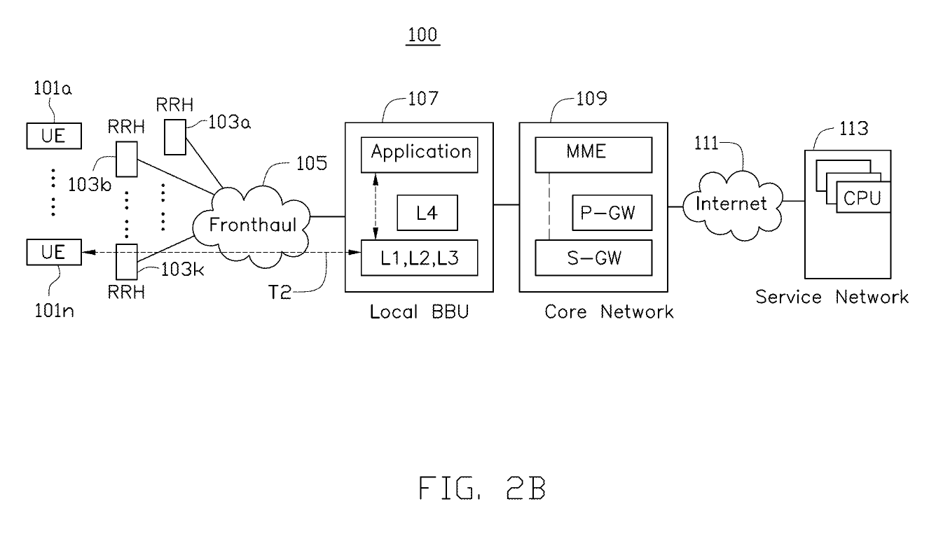

In an exemplary embodiment, when the admission control module of the BBU 107 determines either that the incoming data traffic is delay tolerable data traffic or the available computation resource at the local application server (or the edge node) is insufficient to handle the incoming data traffic, the admission control module of the BBU 107 causes the central node to forward the incoming data traffic to the service network 113, as illustrated by a transmission path T1 (dotted double arrow line) in FIG. 2A. After the service network 113 finishes processing the incoming data traffic, the service network 113 may generate one or more response packets responsive to the incoming data traffic. The service network 113 may further send one or more response packets to the BBU 107. The BBU 107 subsequently sends the one or more response packets received from the service network 113 to the respective UE 101 over the communication network there between.

For another instance, when the admission control module of the BBU 107 determines that the incoming data traffic, received from at least one of the UEs 101 (e.g., temperature sensor with communication capability or a transportation vehicle equipped with temperature detection and reporting mechanism, such as a car), is for data collection purposes, such as an ambient temperature readings of an specific environment, the admission control module causes the central node forwarding/routing the readings to the service network 113 for subsequent data processing and recordation related to the application/service (e.g., temperature monitoring application). The service network 113 sends an acknowledgement response to the BBU 107 and the BBU 107 forwards the response to the respective UE 101, subsequently.

In an exemplary embodiment, when the admission control module of the BBU 107 determines either that the incoming data traffic is delay sensitive data traffic or the available computation resource at the local application server (or the edge node) is sufficient enough to process the incoming data traffic, the admission control module of the BBU 107 causes the central node to forward the incoming data traffic to the local application server (or the edge node) and to locally process the incoming data traffic, as illustrated by a transmission path T2 (dotted double arrow lines), in FIG. 2B. As such, the transmission path is shortened, thereby lowering the overall latency and enhancing the network performance. When the local application server (or the edge node) finishes processing the incoming data traffic and the local application server (or the edge node) may generate one or more response packets responsive to the incoming data traffic. The BBU 107 subsequently sends the one or more response packets to the respective UE 101.

For instance, when the data traffic received by the BBU 107 is delay sensitive, such as an emergency brake warning message transmitted by a transportation vehicle (e.g., a car, a train, or a motorcycle) in case of an accident, the admission control module causes the central node to forward the message to the local application server (or the edge node) to perform mobile edge computation and data processing, The local application server (or the edge node) sends the response to the BBU 107 for the BBU 107 to send the response (e.g., a warning message) to the respective vehicle or vehicles nearby, where the response may be a warning message in the form of one or more data packets.

By installing the admission control module in one tier (e.g., the first tier) of the Fog-RAN network architecture, the admission control module determines that the data traffic flow to be processed in the current tier, the data traffic flow to be processed in a later tier (e.g., the second or the third tier), the tier that processes the data traffic, the reserved communications processing resource of the current network equipment (e.g., the CPU resource reserved for baseband/application processing), and the reserved application processing resource.

In an exemplary embodiment, the admission control module may admit or manage the admission of delay tolerant flows and delay sensitive flow based on the admission control policy that is configured according to the CPU capacity regions of the local application server. The admissible rate may depend on the computation resource required for an application, the communication traffic rate (e.g., downlink or uplink rate), and/or the computation resource required to process and handle the data traffic rate.

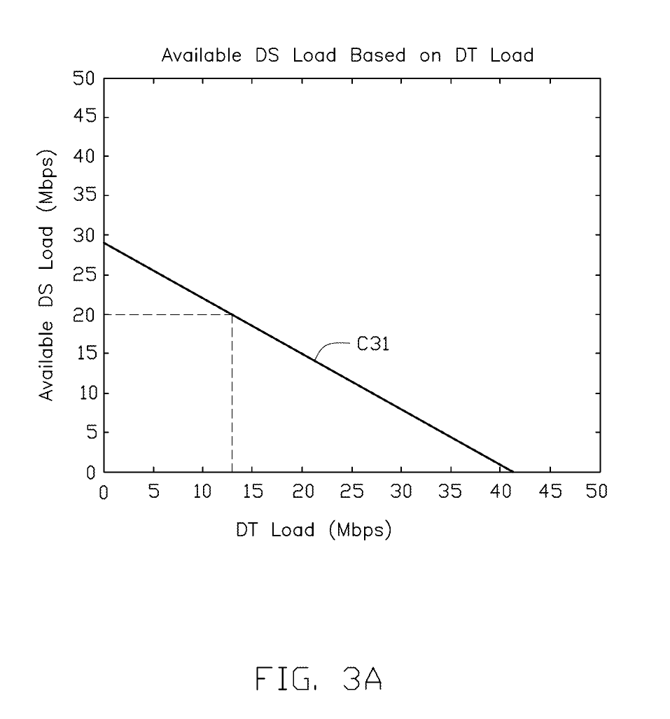

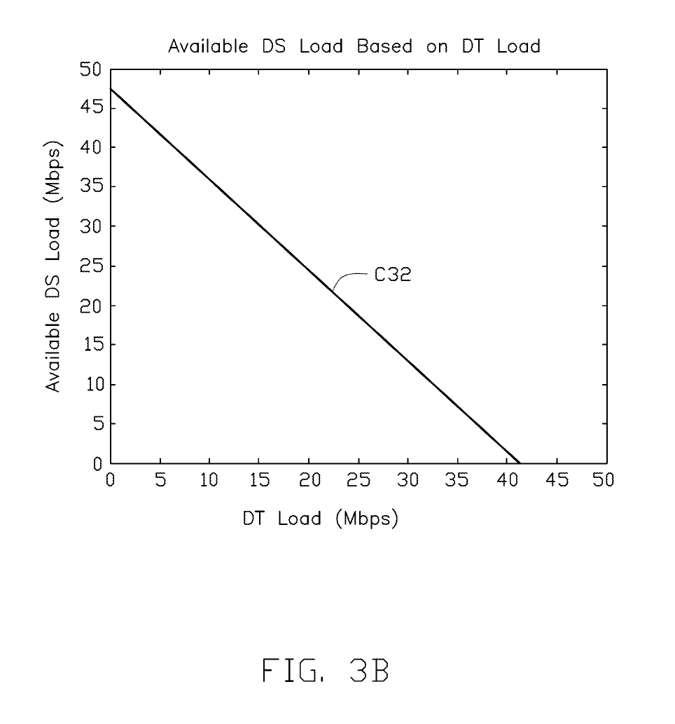

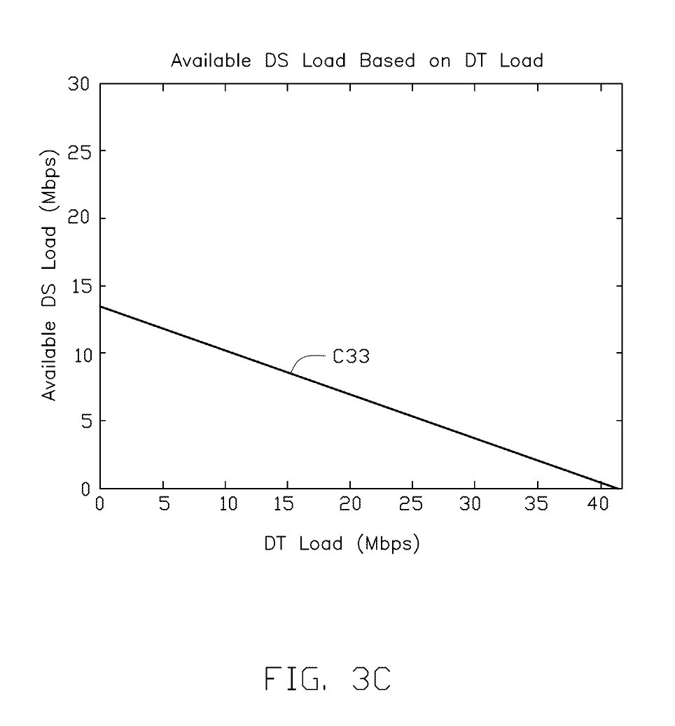

FIGS. 3A to 3C show diagrams illustrating CPU computing load capacity for delay tolerable and delay sensitive traffic load in accordance with exemplary embodiments of the present disclosure. The horizontal axis (e.g., X axis) represents the delay tolerable traffic load, and the vertical axis (e.g., Y-axis) represents available delay sensitive traffic load. Curves C31 to C33 each represent a different admissible rate generated based on data traffic type and the CPU computational loading capacity, in FIGS. 3A, 3B, and 3C, respectively. For instance, according to the CPU capacity region represented by curve C31, when the delay tolerable traffic load is approximately 15 Mbps, the available delay sensitive traffic load is approximately 20 Mbps.

It can be further noted from FIG. 3A to 3C that the delay tolerable traffic load and the available delay sensitive traffic load form an inversely proportional relationship. That is, when the delay tolerable traffic load increases, the computing capacity for delay sensitive traffic load decreases, and vice versa.

In an exemplary embodiment, the admission control module may handle n types of traffic flows, with n-dimensional capacity region, wherein the n is an integer and is greater than or equal to 1. FIG. 3A to 3C merely serve for illustration purposes and should not limited the scope of the present invention.

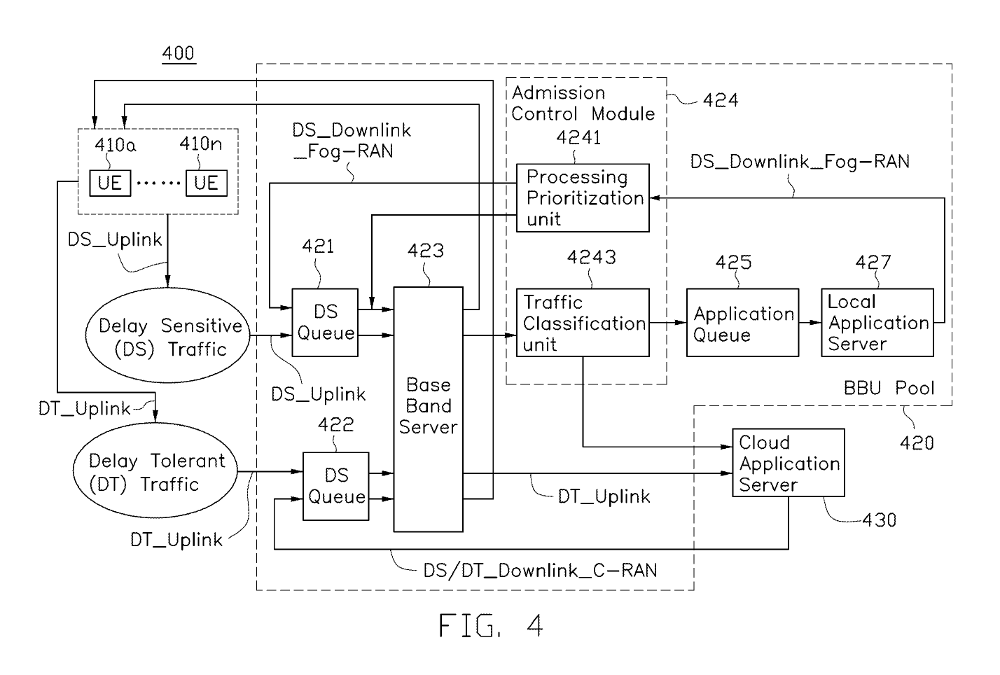

FIG. 4 is a diagram illustrating a data processing and forwarding operation of a Fog radio access network in accordance with an exemplary embodiment of the present disclosure. FIG. 4 depicts a network architecture of a Fog radio access network (Fog-RAN) 400 that adopts a cloud-based radio access network (C-RAN) two-tier network architecture. The Fog-RAN network 400 also adopts a traffic admission control policy for effectively and efficiently controlling and process data flow in the network. The Fog-RAN network 400 includes one or more user equipments (UEs) 401a to 401n, an RRH infrastructure network (omitted for simplicity), a BBU pool 420, and a cloud application server 430 (disposed in a service network). The UEs 401a to 401n may communicate with the BBU pool 420 over a wireless communication network communicatively coupled with the BBU pool 420. The BBU pool 420 may communicate with the cloud application server 430 over a wired or wireless communication network.

In an exemplary embodiment, the cloud application server 430 may be disposed in a data center or cloud computing platform of a service cloud.

In an exemplary embodiment, each of the UEs 401a to 401n may include transportation vehicles with communication capabilities, smart phones, tablets, wearable devices, and laptop. The UEs 401a to 401n may be of the same type or of different types of user equipments in the Fog-RAN network 400.

For a delay tolerable uplink scenario, the data traffic (e.g., one or more data packets) sent by the UEs 410a to 410n in the uplink, as illustrated by a data transmission path DT_Uplink, is first sent to the BBU pool 420 for determining the appropriate processing tier. For example, the data traffic is first sent to a DT Queue 422 for processing before passing to a baseband server 423 (e.g., a BBU), wherein the DT Queue 422 may be a first-in-first-out (FIFO) queue or first-in-last-out (FILO) queue. The DT Queue 422 operatively forwards the data traffic to the baseband server 423 based on the data queue policy adopted. The data traffic is subsequently forwarded from the baseband server 423 to an admission control module 424, which determines whether to process the data traffic locally at the current tier (e.g., the edge node) or to forward the data traffic to the cloud application server 430.

For a delay sensitive uplink scenario, the data traffic sent by the UEs 410a to 410n in the uplink, as illustrated by a data transmission path DS_Uplink, is first sent to a DS Queue 421 of the BBU pool 420 over a communication network. Similarly, the DS Queue 421 may be a first-in-first-out (FIFO) queue or first-in-last-out (FILO) queue. The DS Queue 421 outputs the data traffic through the baseband server 423 to a traffic classification unit 4243 of the admission control module 424 for identifying the volume of the data traffic and the CPU loading of a local application server 427. When the traffic classification unit 4243 determines that the volume of the data traffic is too large for the current CPU loading to handle, the admission control module 424 forwards the data traffic to the cloud application server 430. On the other hand, when the traffic classification unit 4243 determines that the volume of the data traffic is low and the current CPU loading has sufficient computational resource to handle the data traffic, the traffic classification unit 4243 forwards the data traffic to an application queue 425, wherein the application queue 425 outputs the data traffic to the local applications server 427, where the data traffic is processed locally at the local application server 427 within the BBU pool 420.

For a delay sensitive and delay tolerant downlink under a C-RAN scenario, as shown by a data transmission path DS/DT_Downlink_C-RAN, the responses (corresponding to the data traffic processed) are transmitted directly, by the cloud application server 430 to the baseband server 423 of the BBU pool 420. The baseband server 423 of the BBU pool 420 subsequently transmits the response received in the downlink down to the respective UEs 410a to 410n via DT Queue 422 over the communication network.

For a delay sensitive and delay tolerant downlink under a Fog-RAN scenario, as shown by a data transmission path DS_Downlink_Fog-RAN, the responses (corresponding to the data traffic) are transmitted, by the local application server 427 to the processing prioritization unit 4241, where the processing prioritization unit 4241 prioritizes the responses accordingly (e.g., based on the delay sensitivity or processing sequence) and route the data traffic responses to the baseband server 423 for the baseband server 423 to transmit in the downlink back to the corresponding UEs 410a to 410n.

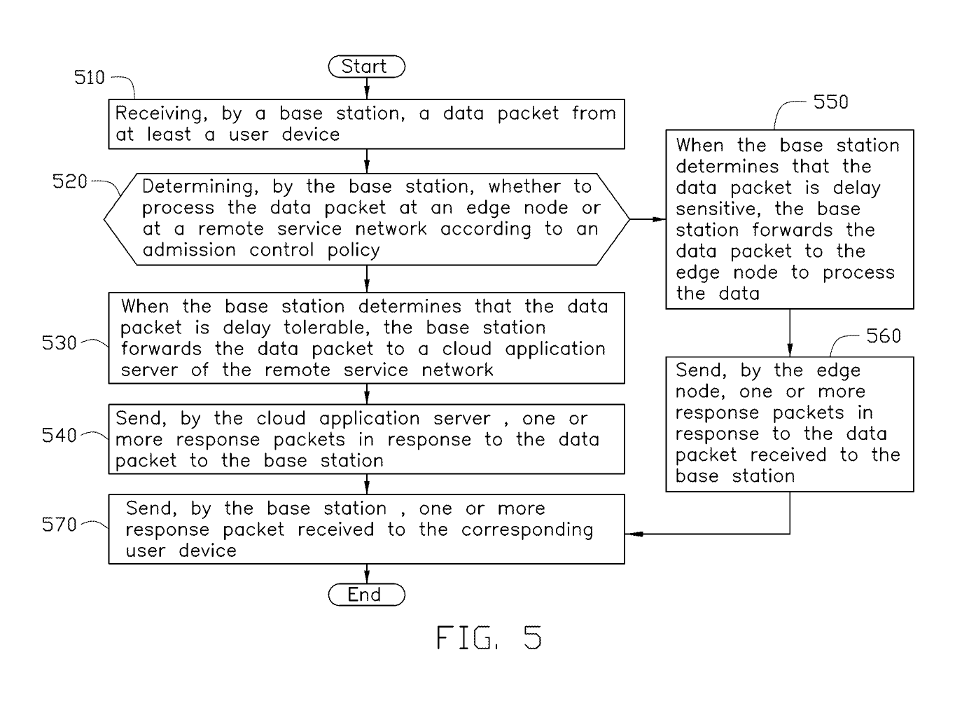

FIG. 5 is a diagram illustrating an exemplary method for managing network traffic in accordance with an exemplary embodiment of the present disclosure. The admission control method depicted in FIG. 5 may be applied to the network architecture of a Fog radio access network (Fog-RAN) that adopts a cloud-based radio access network (C-RAN) multi-tier network architecture, such as the Fog-RAN network 100 in FIG. 1 or the Fog-RAN network 400 in FIG. 4, that adopts a traffic admission control policy for effectively and efficiently controlling and process data flow in the network. The aforementioned admission control module executes the admission control method via firmware writing or software programming. In particular, the admission control module may be implemented by programming a general purpose processor capable of performing communication processing (e.g., LTE (or 5G) processing, baseband processing, protocol processing, and the like) with the necessary codes or firmware to execute the admission control method depicted in FIG. 5.

In block 510, at least one of the user equipments (e.g., a transportation vehicle, a smartphone, a tablet, or a wearable electronic device) in a Fog-RAN network transmits one or more data packets (collectively form at least one data traffic) to a baseband unit (BBU) over a communication network.

In block 520, a built-in admission control module in the BBU identifies the delay characteristics of the data traffic (e.g., a delay sensitive data traffic or a delay tolerable data traffic) and determines whether to process the data packet locally at an edge node or forward to a remote service network according to a pre-configured admission control policy.

The admission control policy may be generated and configured based on at least one of the volume of the incoming data traffic, the computational resources available at the local application server (or the edge node), required computational resource for communications processing, and the combination thereof.

In block 530, when the admission control module of the BBU determines that the data traffic is delay tolerable traffic and/or the computation loading of the local application server (e.g., the CPU loading) is insufficient to handle and process the data traffic, the BBU subsequently forwards the data traffic (e.g., one or more data packets) to a cloud application server of the remote service network for subsequently application processing.

In block 540, upon finishing processing the received data traffic (e.g., one or more data packets), the cloud application server sends one or more response packets (e.g., acknowledgement, content providing, or request response) in response to the data traffic (e.g., one or more data packets) processed to the BBU.

In block 550, when the admission control module of the BBU determines that the data traffic (e.g., one or more data packets) is delay sensitive traffic and/or the computation loading of the CPU is sufficient to support the data traffic, the BBU forwards the data packet to a local application server of the edge node. The edge node in an exemplary embodiment may be incorporated in the BBU (e.g., in an application layer).

In block 560, upon finishing processing the one or more data packets received, the local application server located at the edge node sends one or more response packets in response to the data packet to the BBU for sending the response packets back to the corresponding user equipment.

In block 570, the BBU sends out one or more response packet received from the local application server or the cloud application server in the downlink to the corresponding user equipment.

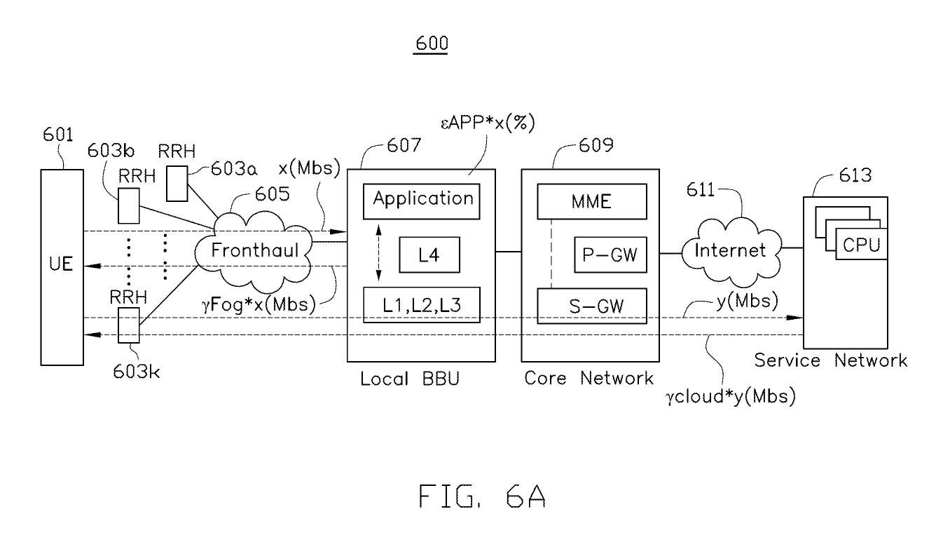

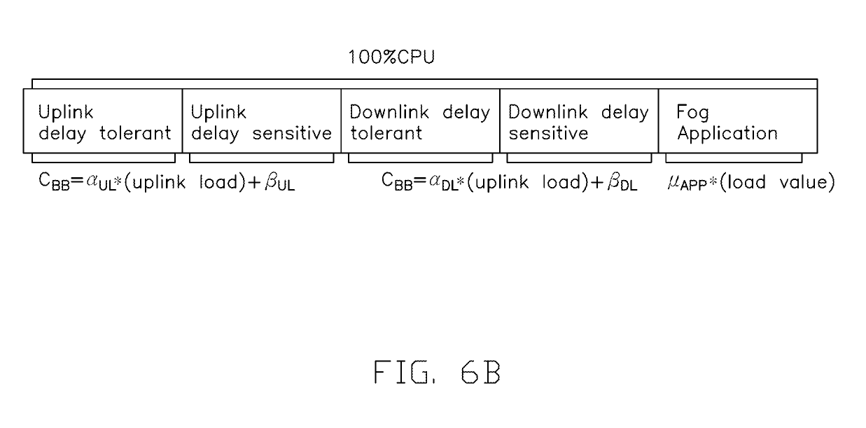

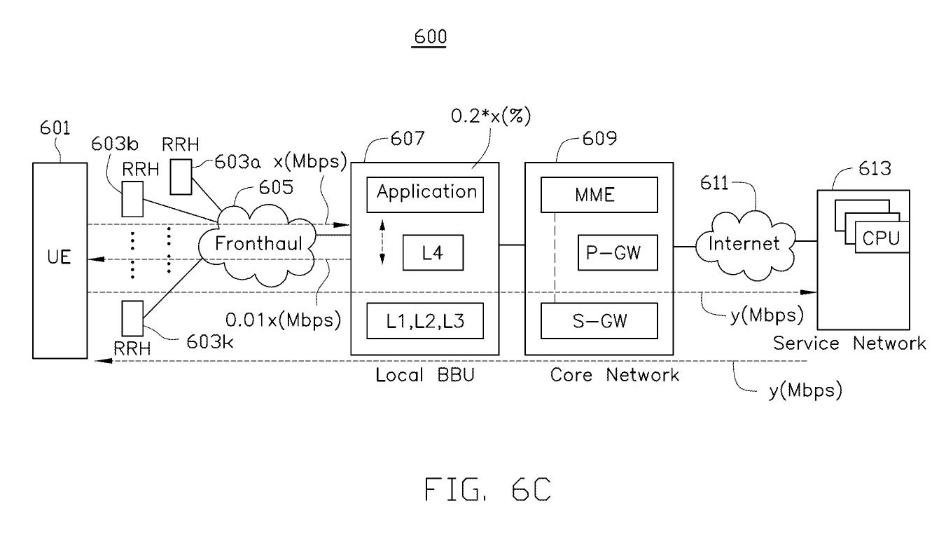

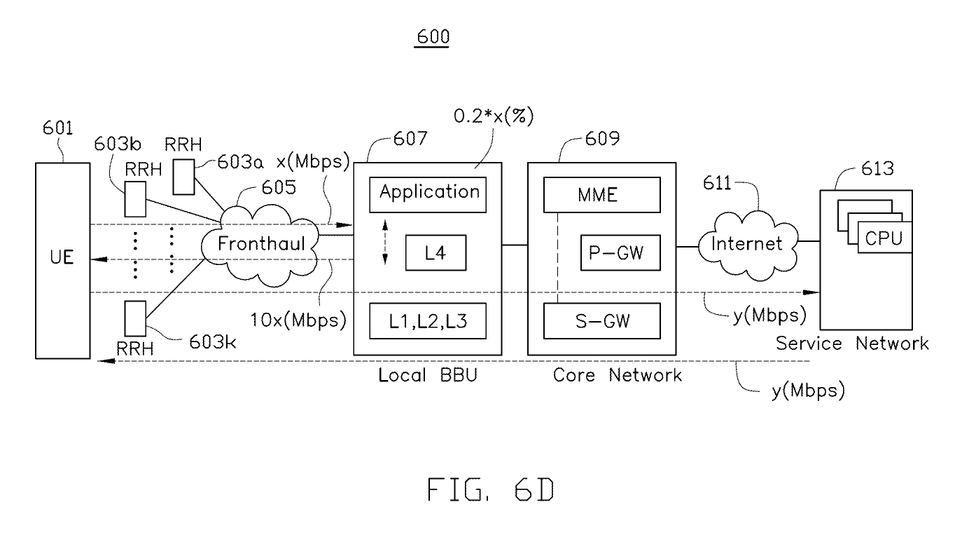

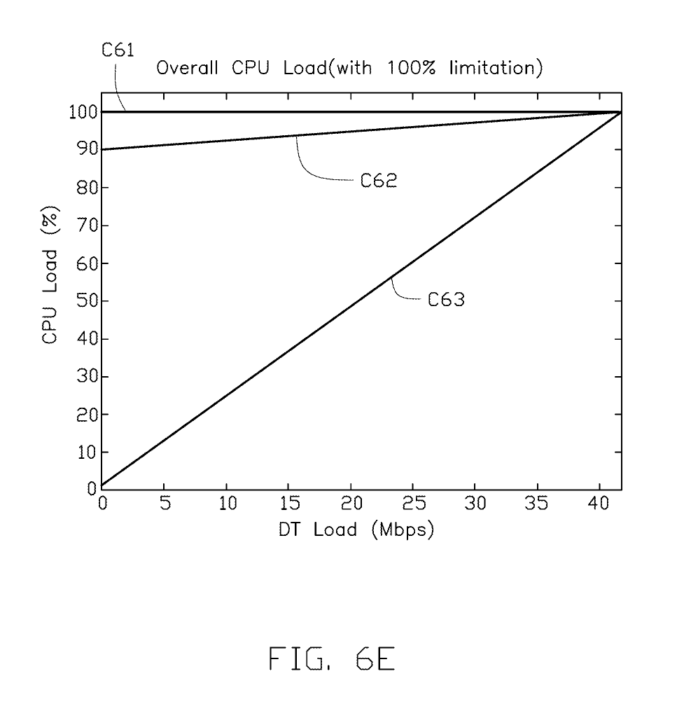

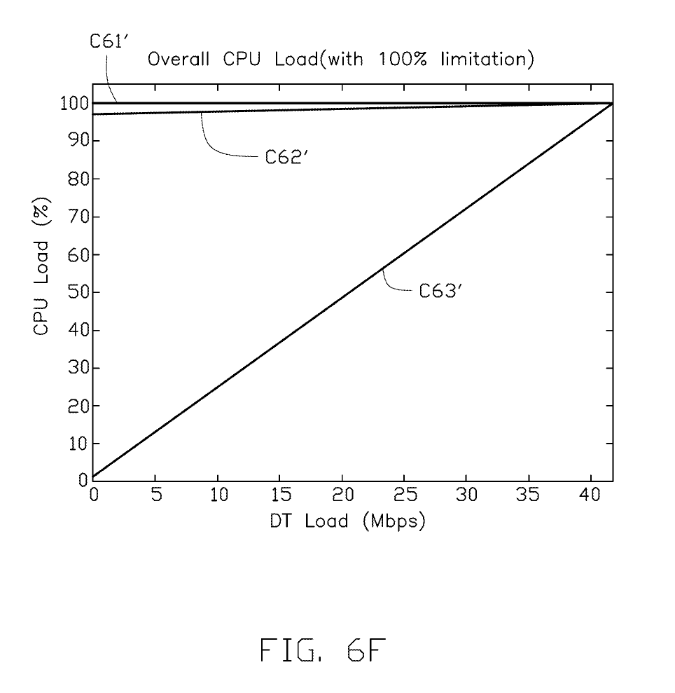

FIG. 6A shows a resource allocation setting for a Fog radio access network in accordance with an exemplary embodiment of the present application. The resource monitor and management mechanism for an edge node (e.g., eNB or gNB). The edge node may be configured based on general purpose processing (GPP) platform (e.g. x86 server based architecture for handling LTE or 5G data traffic) In a resource allocation setting, the local BBU 607 may be configured to receive an uplink delay sensitive traffic load of x (Mbps) data traffic transmit to a local BBU 607 from a UE 601 via a RRH network (RRH 603a to 603k) and a fronthaul network 605, and forward an uplink delay tolerable traffic of v (Mbps) to a service network 613 via an internet network. The local BBU 607 may allocate ε_{APP}*uplink load value (Mbps) or e_{APP}*x(Mbps) computation resource to process the uplink delay sensitive traffic load of x (Mbps). Assuming the computing capacity of the local BBU 607 is infinite, the local BBU 607 may send back a downlink data traffic load of γ_{Fog}*x (Mbps) for a Fog-RAN application (delay sensitive) after processing. The service network 613 may send back a downlink data traffic load of γ_{cloud}*y(Mbps) for a C-RAN application (delay tolerable) after processing. It is noted that ε_{APP}, γ_{Fog}, and γ_{cloud} are network configuration coefficients configured based on network application and communication requirements.

FIG. 6B shows a downlink/uplink resource allocation model for a Fog radio access network in accordance with an exemplary embodiment of the present disclosure. As illustrated in FIG. 6B, computation resources associated with the CPU at the edge node may be allocated based on delay requirements (e.g., delay tolerant, delay sensitive, and the like). Computation resources associated with the CPU at the edge node may be allocated based on uplink traffic flows or downlink traffic flows. Computation resources associated with the CPU at the edge node may be allocated based on Fog application processing (e.g. Fog computing application or Fog service application). Moreover, certain computation resources may be reserved (not shown) for unexpected incoming data traffic, communication processing (e.g., higher layer MAC/RRC/TCP computation or computational load surge). Computation resources associated with the CPU at the edge node may be allocated for background processing tasks (e.g., LTE or 5G processing).

FIG. 6C shows one resource allocation settings for a Fog radio access network in accordance with an exemplary embodiment of the present disclosure. In one resource allocation embodiment, an alarm service in a vehicular network collects vehicular data, such as geographical and movement information (e.g., speed, direction) and alarm the occupants of the vehicle if a crash is predicted. The UE (e.g., a transportation vehicle or a traffic infrastructure) may uplink background data including but limited to geographical (GPS data) and speed information. The local BBU 607 may process the uplink data locally, as it is delay sensitive data traffic. The local BBU 607 may allocate 0.2 x (%) computation resources as the process requires low computation processing and provides downlinks a small message in the size of 0.01 x(Mbps) based on the uplink data, for instance, a safe message or a warning message.

FIG. 6D shows one resource allocation settings for a Fog radio access network in accordance with an exemplary embodiment of the present application. In another resource allocation embodiment, e.g., video streaming broadcasting services in a stadium. Users use their UEs (e.g., tablets or smart phones) for video streaming/broadcasting services (e.g., watching highlights or replays), for example, in a sports stadium. Under the Fog-RAN architecture of the present exemplary embodiment, the broadcast videos can be stored in the local BBU 607, UEs 601 (e.g., tablets and smart phone) only need to send a content delivering request to the local BBU 607, and can receive video streaming from the local BBU 607 in return. Since video streaming is delay sensitive data traffic, the local BBU 607 may process the uplink data locally. The local BBU 607 may allocate 0.2 x (%) computation resources and provides large downlinks data (e.g., video content) in size of 10 x(Mbps) to the corresponding UEs 601.

The usage of the BBU 607 for unlink transmission may be represented as C_{BB}=α_{UL}*(uplink_load)+β_{UL}, assuming that the computing resource consumption for the baseband processing can be predicted as a linear function. The usage of the BBU 607 for downlink transmission may be represented as C_{BB}=α_{DL}*(downlink_load)+β_{DL}. The usage of the BBU 607 for Fog application may be represented as μ_{APP}*load_value. α_{UL}, β_{UL}, α_{DL}, and β_{DL} are uplink and downlink data computing load coefficients configured based on network traffic and the computing load capacity of the BBU 607.

FIGS. 6E and 6F show diagrams illustrating the CPU resource allocation and the capacity region for the local BBU in accordance with exemplary embodiments of the present application. Curves C61 and C61′ represent CPU loading capacity model for both delay tolerable and delay sensitive traffic with Fog-RAN computing. Curves C62 and C62′ represent CPU loading capacity model for both delay tolerable and delay sensitive data traffic. Curves C63 and C63′ represent CPU loading capacity model for delay tolerable data traffic. Under the allocation setting shown in FIG. 6E, most of the computing resources are utilized for delay tolerant and delay sensitive uplink baseband processing. Under the allocation setting shown in FIG. 6F, the computing resources are mostly used for delay tolerant downlink transmission.

In another embodiment, for virtual reality (VR) applications, the local BBU 607 may serve as the UE's VR server. Under this setting, the local BBU 607 may use most of its computing resources for VR computation. Thus, the local BBU 607 would require more computing resources for VR service computing applications.

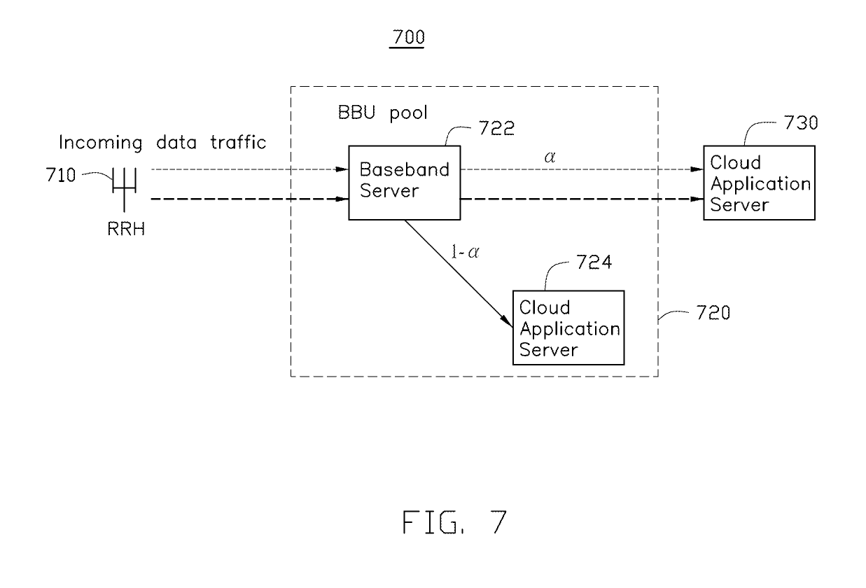

FIG. 7 shows a network traffic forwarding operation model for a cloud-RAN based Fog radio access network in accordance with an exemplary embodiment of the present application. A Fog-RAN network 700 includes a RRH network 710, a BBU pool 720, and a cloud application server 730. The BBU pool 720 adopts a traffic forwarding mechanism for handling and selectively forwarding the incoming data traffic flows from the RRH 710 to the next tier of multi-tier architecture. For example, a baseband server 722 (e.g., a Fog eNB), may forward traffic to a cloud application server 730 over a communication network according to a traffic forwarding policy.

Specifically, the BBU pool 722 may locally serve a portion of the incoming data traffic with local application processing resources or a local application server 724, and forward the remaining portion of the incoming data traffic to the next tier of application processing resource, such as the cloud application server 730. The local application server 724 may be MEC resource in eNB or MEC resource in C-RAN.

The traffic forwarding policy may be configured based on a ratio. Specifically, the traffic forwarding policy may be configured based on a probability parameter, α. For example, the baseband server 722 of the BBU pool 720 may forward a fixed portion of (α) of traffic to the next tier and serve the remaining traffic (1-α) portion in the local application server 724. The data packets to be served in local application server may be prioritized based on the traffic flow type or delay-tolerance type. In one exemplary embodiment, the traffic forwarding policy may prioritize the local processing for delay sensitive data traffic flows.

In one exemplary embodiment, the probability parameter a may be a parameter that is configured based on the network operational requirement, network conditions, or computational load. In another example, each data packet is randomly decided to be forwarded to the next tier with probability a and to be served in local application server 724 with probability 1-α. In one exemplary embodiment, the probability a may be a parameter configured based on the network operational requirement or network conditions.

The present application further provides a Fog radio access network including a traffic control apparatus implementing a method for managing a network traffic. In some embodiments, the traffic control apparatus is installed in a BBU. The traffic control apparatus includes a memory and a processor. The memory is coupled to processor. The memory stores an admission control policy for regulating the data traffic flow in the Fog-RAN network. The admission control policy regulates the data processing path in response to at least one characteristic of a data traffic. In some embodiments, the characteristics include a delay characteristic. Thus, the data traffic includes a delay sensitive data traffic and a delay tolerable data traffic. The processor is configured to identify the delay characteristic of a data traffic received from a user equipment. The data traffic includes at least one data packet generated and sent by the user equipment.

The present application discloses a method for managing a network traffic of a radio access network, the method comprising steps of identifying, by a processor of a baseband unit (BBU), at least one characteristic of a data traffic received from at least one user equipment and determining, by the processor, whether to process locally at an edge node or at a remote service network in response to the at least one characteristic of the data traffic received from the user equipment.

In some embodiments, the characteristic of the data traffic includes a delay characteristic, where when the processor identifies that the data traffic is a delay sensitive data traffic, the processor is configured to process the delay sensitive data traffic locally and forward the data traffic to the edge node, and where when the processor identifies that the data traffic is a delay tolerable data traffic, the processor is configured to forward the delay tolerable data traffic to a service network communicatively linked to the BBU.

In some embodiments, the characteristic of the data traffic further includes computational resource for application processing of the data traffic.

In some embodiments, the characteristic of the data traffic further includes computational resource for communication processing of the data traffic.

In some embodiments, the communication processing of the data traffic includes baseband processing and higher layer protocol processing.

In some embodiments, the data traffic comprises at least one data packet.

In some embodiments, the method further includes allocating, by the edge node, computation resource in response to a delay characteristic.

In some embodiments, the delay characteristic includes a delay tolerant characteristic and a delay sensitive characteristic.

In some embodiments, the method further includes allocating, by the edge node, computation resource in response to at least one uplink flow.

In some embodiments, the method further includes allocating, by the edge node, computation resource in response to at least one downlink flow.

In some embodiments, the method further includes allocating, by the edge node, computation resource in response to at least one application processing.

In some embodiments, the application processing includes a Fog computing application.

In some embodiments, the method further includes reserving, by the edge node, computation resource in response to at least one unexpected incoming traffic.

In some embodiments, the method further includes reserving, by the edge node, computation resource in response to at least one computational load surge.

In some embodiments, the method further includes allocating, by the edge node, computation resource in response to at least one background processing task.

In some embodiments, the method further includes forwarding, by a network node of the Fog radio access network, at least one traffic flow to a cloud application server in response to a ratio of a portion of the traffic flow and a remain portion of the traffic flow.

In some embodiments, the network node includes a baseband server.

In some embodiments, the method further includes forwarding, by a network node of the Fog radio access network, a delay sensitive flow to an application server in the Fog radio access network.

In some embodiments, the method further includes sending, by the edge node, one or more response packets in response to the data traffic received to the BBU and sending, by the BBU, one or more response packets received to the user equipment.

In some embodiments, the method further includes sending, by the processor, one or more response packets in response to the data traffic received to the BBU and sending, by the BBU, one or more response packets received to the user equipment.

In some embodiments, the method further includes allocating, by the processor, a local application computing resource in the BBU as the edge node for processing mobile edge computing operation.

The present disclosure discloses a radio access network including a traffic control apparatus implementing a method for managing a network traffic, the traffic control apparatus comprising a memory configured to store an admission control policy, wherein the admission control policy regulates at least one data processing path for a data traffic received from a user equipment and a processor coupled to the memory and configured identifying at least one characteristic of the data traffic and determining whether to process locally at an edge node or at a remote service network in response to the at least one characteristic of the data traffic.

In some embodiments, the characteristic of the data traffic includes a delay characteristic, wherein when the processor identifies that the data traffic is a delay sensitive data traffic, the processor is caused to process the delay sensitive data traffic locally and forward the data traffic to the edge node and when the processor identifies that the data traffic is a delay tolerable data traffic, the processor is caused to forward the delay tolerable data traffic to a service network communicatively linked to the BBU.

In some embodiments, the characteristic of the data traffic further includes computational resource for application processing of the data traffic.

In some embodiments, the characteristic of the data traffic further includes computational resource for communication processing of the data traffic.

In some embodiments, the communication processing of the data traffic includes baseband processing and higher layer protocol processing.

In some embodiments, the edge node is configured to allocate computation resource in response to a delay characteristic.

In some embodiments, the delay characteristic includes a delay tolerant characteristic and a delay sensitive characteristic.

In some embodiments, the edge node is configured to allocate computation resource in response to at least one uplink flow.

In some embodiments, the edge node is configured to allocate computation resource in response to at least one downlink flow.

In some embodiments, the edge node is configured to allocate computation resource in response to at least one application processing.

In some embodiments, the application processing includes a Fog computing application.

In some embodiments, the edge node is configured to reserve computation resource in response to at least one unexpected incoming traffic.

In some embodiments, the edge node is configured to reserve computation resource in response to at least one computational load surge.

In some embodiments, the edge node is configured to allocate computation resource in response to at least one background processing task.

In some embodiments, the radio access network further includes a network node configured to forward at least one traffic flow to a cloud application server in response to a ratio of a portion of the traffic flow and a remain portion of the traffic flow.

In some embodiments, the network node includes a baseband server.

In some embodiments, the radio access network further includes a network node configured to forward a delay sensitive flow to an application server in the Fog radio access network.

In some embodiments, the data traffic comprises at least one data packet.

In some embodiments, the edge node is configured to send one or more response packets in response to the data traffic received to the BBU.

In some embodiments, the processor is configured to send one or more response packets in response to the data traffic received to the base BBU.

In some embodiments, the processor is configured to allocate a local application computing resource in the BBU as the edge node for processing mobile edge computing operation.

When the processor identifies that the data traffic is a delay sensitive data traffic, the processor determines to process the delay sensitive data traffic locally and forward the data traffic to an edge node. When the processor identifies that the data traffic is a delay tolerable data traffic, the processor determines to forward the delay tolerable data traffic to a service network communicatively linked to the BBU.

The foregoing describes features of several exemplary embodiments so that those skilled in the art may better understand the aspects of the present application. Those skilled in the art should appreciate that they may readily use the present application as a basis for designing or modifying other processes and structures for carrying out the same purposes and/or achieving the same advantages of the exemplary embodiments introduced herein. Those skilled in the art should also realize that such equivalent constructions do not depart from the spirit and scope of the present application, and that they may make various changes, substitutions, and alterations herein without departing from the spirit and scope of the present application.

What is claimed is:

1. A method for managing a network traffic of a radio access network, the method comprising steps of:
identifying, by a processor of a baseband unit (BBU), at least one characteristic of a data traffic received from at least one user equipment; and
determining, by the processor, whether to process locally at an edge node or at a remote service network in response to the at least one characteristic of the data traffic received from the user equipment.

2. The method of claim 1, wherein the characteristic of the data traffic includes a delay characteristic, wherein:
when the processor identifies that the data traffic is a delay sensitive data traffic, the processor is configured to process the delay sensitive data traffic locally and forward the data traffic to the edge node; and
when the processor identifies that the data traffic is a delay tolerable data traffic, the processor is configured to forward the delay tolerable data traffic to a service network communicatively linked to the BBU.

3. The method of claim 1, wherein the characteristic of the data traffic further includes computational resource for application processing of the data traffic.

4. The method of claim 1, wherein the characteristic of the data traffic further includes computational resource for communication processing of the data traffic.

5. The method of claim 4, wherein the communication processing of the data traffic includes baseband processing and higher layer protocol processing.

6. The method of claim 1, wherein the data traffic comprises at least one data packet.

7. The method of claim 1 further including allocating, by the edge node, computation resource in response to a delay characteristic.

8. The method of claim 7, wherein the delay characteristic includes a delay tolerant characteristic and a delay sensitive characteristic.

9. The method of claim 1 further including allocating, by the edge node, computation resource in response to at least one uplink flow.

10. The method of claim 1 further including allocating, by the edge node, computation resource in response to at least one downlink flow.

11. The method of claim 1 further including allocating, by the edge node, computation resource in response to at least one application processing.

12. The method of claim 11, wherein the application processing includes a Fog computing application.

13. The method of claim 1 further including reserving, by the edge node, computation resource in response to at least one unexpected incoming traffic.

14. The method of claim 1 further including reserving, by the edge node, computation resource in response to at least one computational load surge.

15. The method of claim 1 further including allocating, by the edge node, computation resource in response to at least one background processing task.

16. The method of claim 1 further including forwarding, by a network node of the Fog radio access network, at least one traffic flow to a cloud application server in response to a ratio of a portion of the traffic flow and a remain portion of the traffic flow.

17. The method of claim 16, wherein the network node includes a baseband server.

18. The method of claim 1 further including forwarding, by a network node of the Fog radio access network, a delay sensitive flow to an application server in the Fog radio access network.

19. The method of claim 1 further including:
sending, by the edge node, one or more response packets in response to the data traffic received to the BBU; and
sending, by the BBU, one or more response packet received to the user equipment.

20. The method of claim 1 further including:
sending, by the processor, one or more response packets in response to the data traffic received to the BBU; and
sending, by the BBU, one or more response packet received to the user equipment.

21. The method of claim 1 further including allocating, by the processor, a local application computing resource in the BBU as the edge node for processing mobile edge computing operation.

22. A radio access network including a traffic control apparatus implementing a method for managing a network traffic, the traffic control apparatus comprising:
a memory configured to store an admission control policy, wherein the admission control policy regulates at least one data processing path for a data traffic received from a user equipment;
a processor coupled to the memory and configured to identify at least one characteristic of the data traffic and determine whether to process locally at an edge node or at a remote service network in response to the at least one characteristic of the data traffic.

23. The radio access network of claim 22, wherein the characteristic of the data traffic includes a delay characteristic, wherein:
when the processor identifies that the data traffic is a delay sensitive data traffic, the processor is caused to process the delay sensitive data traffic locally and forward the data traffic to the edge node; and
when the processor identifies that the data traffic is a delay tolerable data traffic, the processor is caused to forward the delay tolerable data traffic to a service network communicatively linked to the BBU.

24. The radio access network of claim of claim 22, wherein the characteristic of the data traffic further includes computational resource for application processing of the data traffic.

25. The radio access network of claim 22, wherein the characteristic of the data traffic further includes computational resource for communication processing of the data traffic.

26. The radio access network of claim 25, wherein the communication processing of the data traffic includes baseband processing and higher layer protocol processing.

27. The radio access network of claim 22, wherein the edge node is configured to allocate computation resource in response to a delay characteristic.

28. The radio access network of claim 27, wherein the delay characteristic includes a delay tolerant characteristic and a delay sensitive characteristic.

29. The radio access network of claim 22, wherein the edge node is configured to allocate computation resource in response to at least one uplink flow.

30. The radio access network of claim 22, wherein the edge node is configured to allocate computation resource in response to at least one downlink flow.

31. The radio access network of claim 22, wherein the edge node is configured to allocate computation resource in response to at least one application processing.

32. The radio access network of claim 31, wherein the application processing includes a Fog computing application.

33. The radio access network of claim 22, wherein the edge node is configured to reserve computation resource in response to at least one unexpected incoming traffic.

34. The radio access network of claim 22, wherein the edge node is configured to reserve computation resource in response to at least one computational load surge.

35. The radio access network of claim 22, wherein the edge node is configured to allocate computation resource in response to at least one background processing task.

36. The radio access network of claim 22 further including a network node configured to forward at least one traffic flow to a cloud application server in response to a ratio of a portion of the traffic flow and a remain portion of the traffic flow.

37. The radio access network of claim 36, wherein the network node includes a baseband server.

38. The radio access network of claim 22 further including a network node configured to forward a delay sensitive flow to an application server in the Fog radio access network.

39. The radio access network claim 22, wherein the data traffic comprises at least one data packet.

40. The radio access network of claim 22, wherein the edge node is configured to send one or more response packets in response to the data traffic received to the BBU.

41. The radio access network of claim 22, wherein the processor is configured to send one or more response packets in response to the data traffic received to the base BBU.

42. The radio access network of claim 22, wherein the processor is configured to allocate a local application computing resource in the BBU as the edge node for processing mobile edge computing operation.
